(19) United States
(12) Patent Application Publication
(10) Pub. No.: US 2003/0005996 A1
(43) Pub. Date: Jan. 9, 2003

(54) Window or door assemblies

(76) Inventor: Martin Althorpe, Kettering (GB)

Correspondence Address: Kenneth I. Kohn, KOHN & ASSOCIATES, Suite 410, 30500 Northwestern Highway, Farmington Hills, MI, 48334, US

(21) Appl. No.: 09/769,196

(22) Filed: Jan. 24, 2001

(51) Int. Cl. G02B 1/00

(52) U.S. Cl. 156/106; 156/99

(57) ABSTRACT

A glazed window frame assembled from profile portions (2) has first and second sheets of glass (4, 6) to provide a complete glazed window frame, for example for use in an outer frame (8). First and second adhesive means (10, 12) are applied to first and second parts (14, 16) of the profile portions (2) and the first glass sheet (4) is secured to profile portion (2) by virtue of first adhesive means (10). A second sheet of glass (6) is subsequently secured to the profile portion (2) by virtue of second adhesive means (12), and an optional third adhesive means (18) may be applied to an optional trim element (20) which is then located against the other side of sheet (6).

### TECHNICAL FIELD

The present invention relates to the manufacture of windows and, in particular, to the manufacture of glazed door or window frames for buildings.

### BACKGROUND OF THE INVENTION

The known method of producing a glazed PVC window frame involves a number of assembly steps. PVC extruded profiles are manufactured and assembled into fixed or opening frames. A sealed double glazed unit is then located in the frame and fixed in place by beads. Gaskets or seals are snapped into place between the frame members and the sides of the sealed unit. Such a method is labour intensive and relatively costly since most of the assembly steps have to be undertaken manually, particularly the steps of fixing the sealed unit into the frame and applying the gaskets.

The present invention has been made from a consideration of the disadvantages with such a known production method and in order to provide an improved method which is more cost effective, less labour intensive and is suitable for automation if desired. The present invention is not restricted to PVC extruded profiles.

### SUMMARY OF THE INVENTION

According to a first aspect of the present invention there is provided a method of manufacturing a glazed door or window frame comprising the steps of:

(i) assembling a rectangular frame from profile portions;

(ii) adhesively binding a first glass sheet to first parts of such profile portions; and

(iii) adhesively binding a second glass sheet to second parts of such profile portions.

Preferably, the first part is located inwardly of the frame relative to the second part so that such profile portions are stepped.

Preferably, the first and second parts of the profile portions are spaced apart across the width of the profile portions. Preferably, a cavity is provided between said first and second parts. Preferably, the cavity is adapted to be filled with a desiccant or like material. Preferably, the first part is located inwardly of the frame relative to the cavity so that the cavity underlies the first glass sheet. Preferably, a desiccant is inserted into a cavity of at least one such profile portion. The method may include inserting a desiccant through an aperture provided in such cavity. Thus the frame of a preferred embodiment of the invention or manufactured according to a preferred method of the invention comprises an in-built moisture inhibition system since both the stepped profile and the integral desiccant prevent the ingress of water through the frame. By contrast, conventional frames require the manufacture and use of a separate unit containing desiccant.

Alternatively or additionally, the method may be carried out in an inert gas atmosphere. Preferably the inert gas is heavier than air. When the method is carried out in such an inert gas atmosphere the desiccant may be dispensed with.

Preferably, the method includes applying adhesive means to such first and second parts and locating the first and second glass sheets against the adhesive means on such first and second parts, respectively. The method may include the steps of extruding the profile portions and cutting the extruded profiles to the desired lengths before assembly.

Preferably, the method includes adhesively binding a trim element to said second glass sheet.

Preferably, the method includes applying adhesive means to said trim element and locating the trim element against said second glass sheet.

Preferably, the periphery of one side of the first and second glass sheets is located against such adhesive means. Preferably, the trim element is located against the periphery of the other side of said second glass sheet.

Preferably, such adhesive means is applied to a recess of such first and second parts and to a recess of said trim element.

Preferably, the first and second parts of such profile portions respectively comprise first and second recesses adapted to receive such adhesive means.

According to a second aspect of the invention there is provided a frame for manufacturing a glazed door or window frame comprising a plurality of profile portions, each profile portion comprising a first part having a first recess adapted to receive adhesive means and a second part having a second recess adapted to receive adhesive means.

Preferably, the profile portions are manufactured from any extrudable material, one example of which is PVC.

Preferably, the first recess is located inwardly of the frame relative to the second recess. Preferably, the first and second recesses are spaced apart across the width of the profile portion.

Preferably, the first glass sheet is inserted into the frame from one side and the second glass sheet is subsequently inserted into the frame from the same side.

Preferably, the first glass sheet abuts said first part of such profile portions and the second glass sheet abuts said second part of such profile portions.

The invention further provides a glazed door or window frame manufactured according to the method of the invention.

### BRIEF DESCRIPTION OF THE INVENTION

The invention will now be described further by way of example only with reference to the accompanying drawings in which:

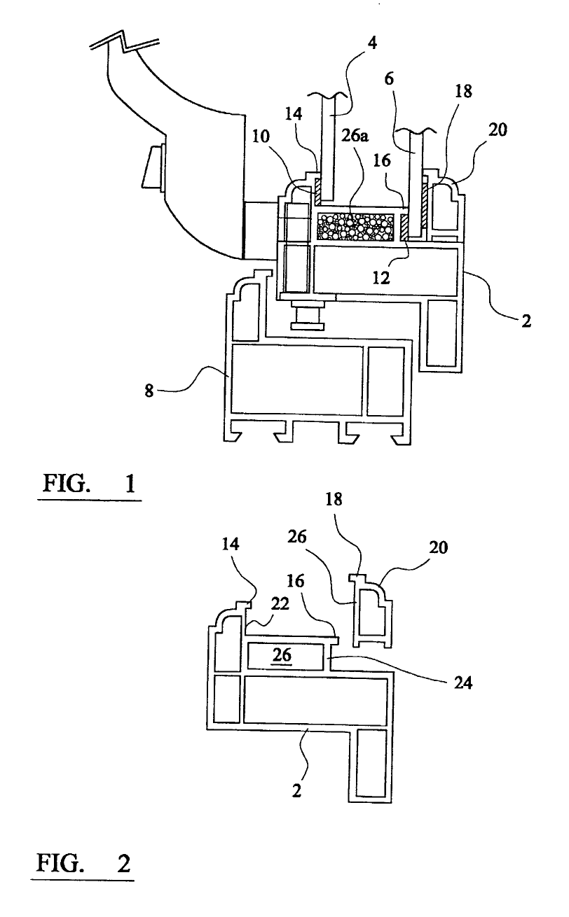

FIG. 1 is a section through a glazed window manufactured according to the method of the invention; and

FIG. 2 is a section through the frame member and trim of FIG. 1.

### DETAILED DESCRIPTION OF THE INVENTION

Referring to the drawings, a glazed window frame manufactured according to the method of the invention comprises a rectangular frame assembled from frame members or profile portions 2, typically PVC extruded profiles although extruded profiles of other materials may be used. First and second sheets of glass 4, 6 are bonded to the profile portions 2 to provide a complete glazed window frame which may be located in use on an outer frame 8. The method typically involves extruding suitable profile portions 2 and assembling the profile portions to form a rectangular frame. First and second adhesive means 10, 12 are applied to first and second parts 14, 16 of the profile portions 2. The first glass sheet 4 is then secured to the profile portion 2 by locating the periphery of one side thereof against the first adhesive means 10 on the first part 14. The second glass sheet 6 is subsequently secured to the profile portion 2 by locating the periphery of one side thereof against the second adhesive means 12 on the second part 16. A third adhesive means 18 is applied to a trim element 20 which is then located against the periphery of the other side of the second glass sheet 6 to thereby secure the trim elements 20 to the second glass sheet 6.

It will be appreciated that the method may involve applying one or more of the first, second or third adhesive means directly to the glass sheets 4, 6 and subsequently locating the profile portions 2 or trim elements 20 against the sheets to procure securement. The adhesive means may comprise any suitable adhesive or adhesive tape. The profile portion 2 comprises first and second recesses or channels 22, 24 for receiving the first and second adhesive means 10, 12. The recesses are defined by overhanging lips on the first and second profile parts, the lips and recesses facing in the same direction so that the first and second glass sheets are located into the frame in the same direction or from the same side of the frame. The first recess is located inwardly of the frame relative to the second recess thereby forming a stepped profile.

The first and second parts of the profile portions are spaced apart across the width of the profile portion, typically with a spacing substantially corresponding to a desired spacing between the first and second glass sheets. The profile portion 2 typically comprises a cavity 26 between the first and second parts. The cavity may be filled with a desiccant 26a or the like material, for example through an aperture into the cavity provided for this purpose. Thus, the method typically also includes inserting a desiccant into one or more cavities of the profile portions. Although it is preferred that a cavity and corresponding aperture are provided for desiccant if required, by assembling the glazed frame under an inert gas atmosphere the need for desiccant is reduced or even eliminated. Preferably the inert gas is heavier than air

The trim element 20 comprises a third recess 26 for receiving the third adhesive means 18. The recess is defined by an overhanging lip on the trim element. In use, the recess faces in the opposite direction to the first and second recesses 22, 24.

Bonding of the glass sheets directly to the frame according to the method of the invention reduces manufacturing costs and allows the method to be automated since the adhesive may be applied and the glass sheets located in place automatically using suitable apparatus. The trim element is simply a decorative trim and is not necessary for maintaining the glass sheets in position The glazed frame of the invention is strong and stable since the glass sheets provide the required strength and stability and avoid the need for frame reinforcement. The profile portions can support window handles or the like. The invention allows glazed window or door frames to be manufactured and sold as a complete unit or sash and avoids the need for separate sealed double glazed units.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of manufacturing a glazed door or window frame comprising the steps of:
(i) assembling a rectangular frame from profile portions (2);
(ii) adhesively binding a first glass sheet (4) to first parts (14) of such profile portions; and
(iii) adhesively binding a second glass sheet (6) to second parts (16) of such profile portions.

2. A method according to claim 1, wherein the first part (14) is located inwardly of the frame relative to the second part (16) so that such profile portions are stepped.

3. A method according to claim 1, wherein the first and second parts (14, 16) of the profile portions are spaced apart across the width of the profile portions.

4. A method according to claim 1, wherein a cavity (26) is provided between said first and second parts).

5. A method according to claim 4, wherein the cavity (26) is adapted to be filled with a desiccant (26a) or like material.

6. A method according to claim 4, wherein the first part (14) is located inwardly of the frame relative to the cavity (26) so that the cavity underlies the first glass sheet (4).

7. A method according to claim 4, wherein a desiccant (26a) is inserted into a cavity of at least one such profile portion.

8. A method according to claim 1, wherein the method is carried out in an inert gas atmosphere.

9. A method according to claim 1, including applying adhesive means (10, 12) to such first and second parts and locating the first and second glass sheets against the adhesive means on such first and second parts, respectively.

10. A method according to claim 1, including the steps of extruding the profile portions and cutting the extruded profiles to the desired lengths before assembly.

11. A method according to claim 1, including adhesively binding a trim element (20) to said second glass sheet.

12. A method according to claim 11, and including applying adhesive means (18) to said trim element and locating the trim element against said second glass sheet.

13. A method according to claim 12, wherein the periphery of one side of the first and second glass sheets is located against such adhesive means (10, 12).

14. A method according to claim 13 wherein the trim element is located against the periphery of the other side of said second glass sheet (6).

15. A method according to claim 12, wherein such adhesive means (10, 12, 18) is applied to a recess of such first and second parts and to a recess of said trim element.

16. A method according to claim 12, wherein the first and second parts of such profile portions respectively comprise first and second recesses (22, 24) adapted to receive such adhesive means.

17. A frame for manufacturing a glazed door or window frame comprising a plurality of profile portions, each profile portion comprising a first part (14) having a first recess (22) adapted to receive adhesive means (10) and a second part (16) having a second recess (24) adapted to receive adhesive means (12).

18. A frame according to claim 17 wherein the first recess (22) is located inwardly of the frame relative to the second recess (24).

19. A frame according to claim 18 wherein the first and second recesses (22, 24) are spaced apart across the with of the profile portion.

20. A frame according to claim 17, or a method according to claim 1, wherein the first glass sheet (4) is inserted into the frame from one side and the second glass sheet (6) is subsequently inserted into the frame from the same side.

21. A frame according to claim 17, wherein the first glass sheet (4) abuts said first part (14) of such profile portions and the second glass sheet (6) abuts said second part (16) of such profile portions.

22. A glazed door or window frame manufactured according to the method of claim 1.
